(19) United States
(12) Patent Application Publication
(10) Pub. No.: US 2008/0163767 A1
(43) Pub. Date: Jul. 10, 2008

(54) Juice Extractor With Safety Device

(76) Inventor: Li-Chen Wu Chang, Pa Te Hsiang (TW)

Correspondence Address: RABIN & Berdo, PC, 1101 14TH STREET, NW, SUITE 500, WASHINGTON, DC, 20005, US

(21) Appl. No.: 11/620,801

(22) Filed: Jan. 8, 2007

(51) Int. Cl. B23Q 15/20

(52) U.S. Cl. 99/492

(57) ABSTRACT

A juice extractor with a safety device is disclosed herein, wherein the improvement includes the juice extractor including a switching device and an actuating part. The switching device is disposed by a feed channel of a juice extractor, and the actuating part is disposed on a food pusher. According to another embodiment of the present invention, the switching device is disposed by an opening of a cup body of the juice extractor and the actuating part is disposed on a lid. When the food pusher is put into the feed channel or the lid securely covers the opening of the juice extractor, the actuating part actuates the switching device to turn on the power. When the food pusher or the lid is removed, the switching device turns off the power, thereby achieving safety for operating the juice extractor.

### BACKGROUND OF THE INVENTION

1. Field of the Invention

The present invention relates to a machine that chops and grinds the vegetables or fruits to extract juice, and in particular to a juice extractor with a safety device.

2. The Prior Arts

The vegetable and juice extractor in the market nowadays usually has a feed channel with a food pusher The food pusher pushes the fruits or vegetables down the feed channel and presses them against a blade disk at the bottom. Thus the fruits or vegetables are chopped and ground into juice.

A power switch controls a motor of the conventional juicer. In other words, when the power switch is turned on, the motor drives the blade disc to rotate continuously; whereas, when the power switch is turned off, the motor and the blade disc stop rotating. This kind of juice extractor has many disadvantages. When the food pusher is away from the feed channel and next piece of fruit isn't pushed in, the blade disc is still rotating. If a foreign object is dropped in the feed channel, the blade disc is struck hard and likely to damage. Even the object is thrown out of the extractor to injure people. Although the user can turn off the power before the food pusher is taken out of the feed channel and turn on the power again after the food pusher push another fruit down the feed channel, it is bothersome to switch on and off repeatedly.

What's more, the conventional juice extractor without food pusher also poses the similar safety problem. Especially a juice extractor with a large opening may pose a danger to kids who can stick their hands down the unit.

### SUMMARY OF THE INVENTION

A primary objective of the present invention is to provide a juice extractor with a safety device to solve the safety problem of a conventional juicer that cannot turn on or off the power automatically depending on whether a food pusher is in a feed channel or a lid securely covers the juice extractor.

The juice extractor with the safety device according to the present invention comprises the following improvement. When the food pusher is put into the feed channel of the juice extractor, the power is turned on automatically and the motor drives a blade disc to rotate. When the food pusher is out of the feed channel, the power is turned off automatically. Thus the safety device prevents the user from injury.

The juice extractor with the safety device according to the present invention comprises another improvement. The power of the fruit juice extractor is turned on and the blade disc is driven to rotate only when the lid securely covers an opening of the fruit juice extractor. The electric power is turned off automatically when the lid does not cover the juicer securely.

A technical feature of the present invention is to provide a switching device at an inner side of a feed channel and an actuating part on the food pusher. The switching device is electrically connected with a power source of a motor. When the food pusher is pushed into the feed channel, the switching device detects the presence of the actuating part and the power is turned on. When the food pusher is removed away from the feed channel, the switching device detects the absence of the actuating part and the power is turned off.

Another technical feature of the present invention is to provide a switching device electrically connected with a power source of a motor at a side of the cup body of a fruit juice extractor. A lid used to cover the cup body is formed with an actuating part. When the lid is placed on and securely covers the opening of the cup body, the actuating part actuates the switching device to turn on the power of the motor. When the lid is opened, the switching device turns off the power.

The switching device may be a magnetic sensor and the actuating part may be a magnetic substance. When the food pusher is put into the feed channel or the lid is positioned and securely covers on the cup body, the magnetic sensor on the feed channel or the cup body detects the presence of the magnetic substance on the food pusher or the lid, respectively. The magnetic sensor then transmits a signal to turn on the power. When the food pusher or the lid is away from the feed channel or the cup body, the magnetic sensor detects the absence of the magnetic substance. Thus the power is turned off.

Besides, the magnetic sensor of the juice extractor according to the present invention may further associate with a safety handle. The safety handle and the magnetic sensor are electrically connected with the power source of the motor. Only when the food pusher is put in the feed channel and the safety handle is operated, the magnetic sensor transmits a signal to turn on the power. When the food pusher is removed from the feed channel or the safety handle is not operated, the magnetic sensor turns off the power.

The switching device according to the present invention may be a micro switch, which is connected with a link and an elastic part. The elastic part is used to push the link away from the micro switch. The actuating part can be a pusher ridge protruded from the sidewall of the food pusher. The pusher ridge pushes the link to contact with and activate the micro switch. Whereas, when the pusher ridge does not push the link to contact with the micro switch, the micro switch cuts off the power.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a cross-sectional view showing a juice extractor with an electronic safety device according to a first embodiment of the present invention when a food pusher is out of a feed channel.

FIG. 2 is a cross-sectional view showing the juice extractor with the electronic safety device according to the first embodiment of the present invention when the food pusher is in the feed channel.

FIG. 3 is a cross-sectional view showing a juice extractor with a mechanical safety device according to a second preferred embodiment of the present invention when a food pusher is out of a feed channel.

FIG. 3A is a top view of a food pusher according to the second preferred embodiment of the present invention.

FIG. 3B is a partial enlarged view of the mechanical safety device according to the second preferred embodiment of the present invention.

FIG. 4 is a cross-sectional view showing the juice extractor with the mechanical safety device according to the second preferred embodiment of the present invention when the food pusher is in the feed channel.

FIG. 5 is a schematic view showing a juice extractor with a safety device according to a third preferred embodiment of the present invention.

### DETAILED DESCRIPTION OF THE PREFERRED EMBODIMENT

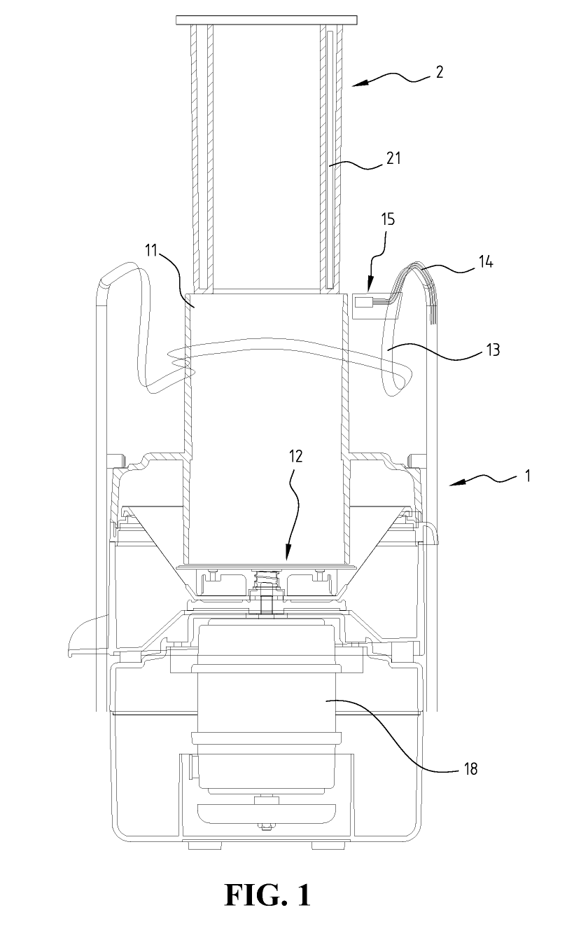

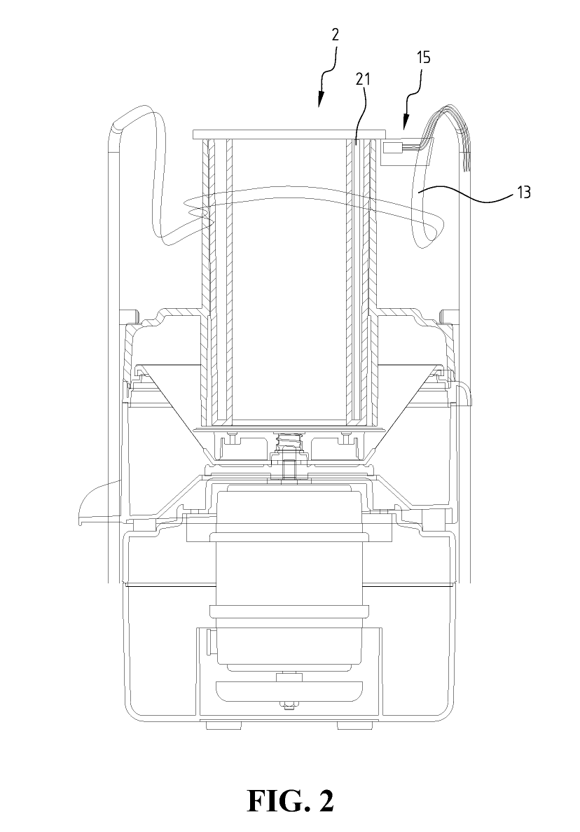

FIGS. 1 and 2 show a juice extractor with a safety device in accordance with a first preferred embodiment of the present invention. The juice extractor comprises an extractor body I and a food pusher 2. Wherein, a feed channel 11 is disposed at an upper section of the extractor body 1 and a cutter device 12 connected with a motor 18 is mounted at a lower section of the feed channel 11. The motor 18 drives the cutter device 12 to rotate when the power is on. The feed channel 11 according to the first embodiment is provided with a magnetic sensor 15 at a sidewall thereof. The magnetic sensor 15 is electrically connected with a power source of the motor 18 by a lead wire 14. A magnetic substance 21, which can be detected by the magnetic sensor 15, is wrapped inside a sidewall of the food pusher 2. Referring to FIG. 2, when the vegetable or fruit is fed into the feed channel 11 and the food pusher 2 is inserted into the feed channel 11, the magnetic sensor 15 detects the presence of the magnetic substance 21 and transmits a signal to turn on the power, whereby the motor 18 drives the cutter device 12 to rotate. When the food pusher 2 is removed from the feed channel 11, the magnetic sensor 15 detects the absence of the magnetic substance 21. Thus the power is turned off.

Moreover, a safety handle 13 may be associated with the magnetic sensor 15 according to the present invention. The magnetic sensor 15 and the safety handle 13 are electrically connected with the power source of the motor 18. When the food pusher 2 is inserted into the feed channel 11 and the safety handle 13 is pushed upwards, the magnetic substance 21 actuate the magnetic sensor 15 to transmit a signal to turn on the power, thereby rotating the motor 18. When the food pusher 2 is removed from the feed channel 11 or the safety handle 13 is not pushed upwards, the magnetic sensor 15 turns off the power.

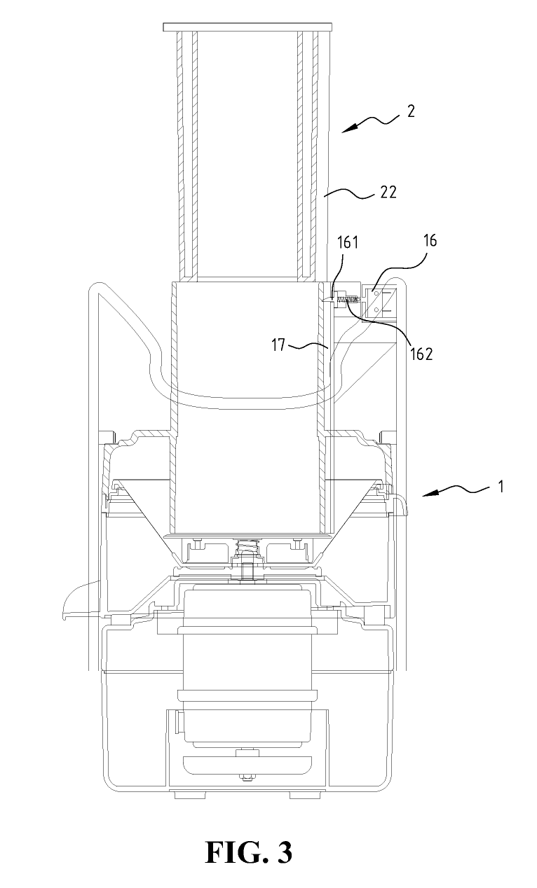

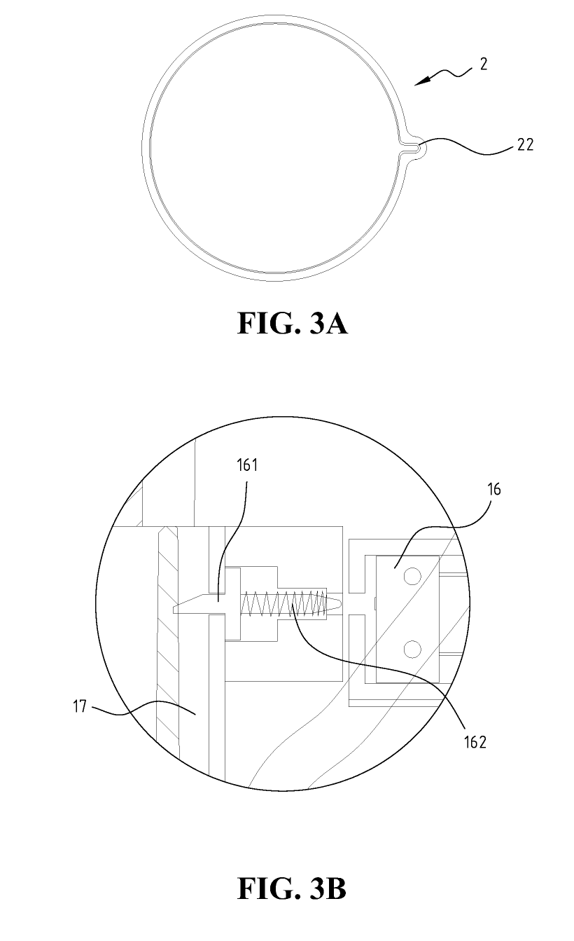

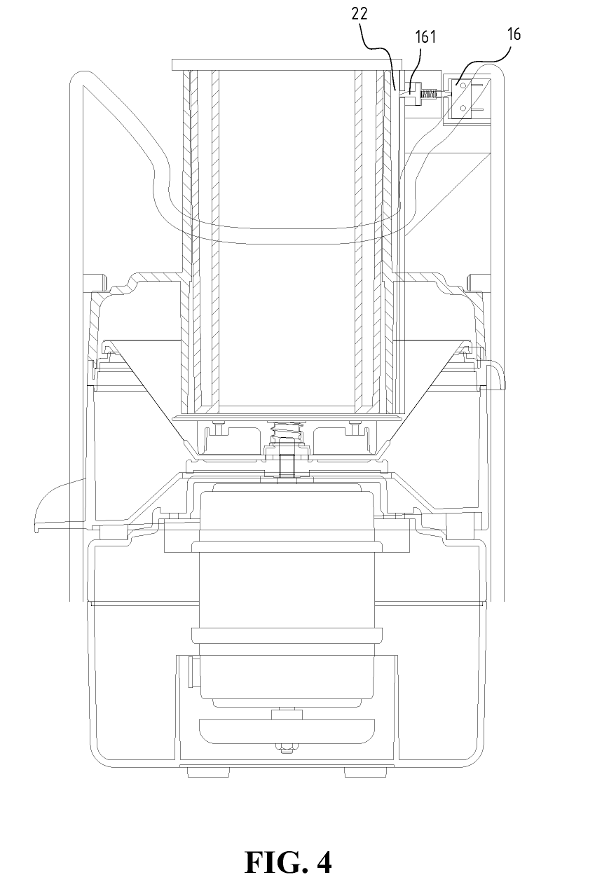

FIGS. 3, 3B and 4 show a juice extractor with a mechanical safety device in accordance with a second preferred embodiment of the present invention. A groove 17 extending in a longitudinal direction is provided on an inner sidewall of the feed channel 11. A micro switch 16 associated with a link 161 and an elastic part 162 is provided below the groove 17. A free end of the link 161 points to the central axis of the feed channel 11. The elastic part 162 is disposed between the micro switch 162 and the link 161, whereby the link 161 keeps a predetermined distance to the micro switch 16. The micro switch 16 is electrically connected with the power source of the motor 18. A longitudinal extending pusher ridge 22 is provided on an outer surface of the food pusher 2 and can move along the corresponding groove 17. Referring to FIG. 4, when the food pusher 2 is inserted into the feed channel 11, the pusher ridge 22 pushes the link 161 to contact with the micro switch 16 to turn on the power. Whereas, when the food pusher 2 is away from the feed channel 11, the pusher ridge 22 does not push the link 161. The link 161 is pushed back by the compressed elastic part 162 to its original position and loses contact with the micro switch 16. Thus the power is turned off.

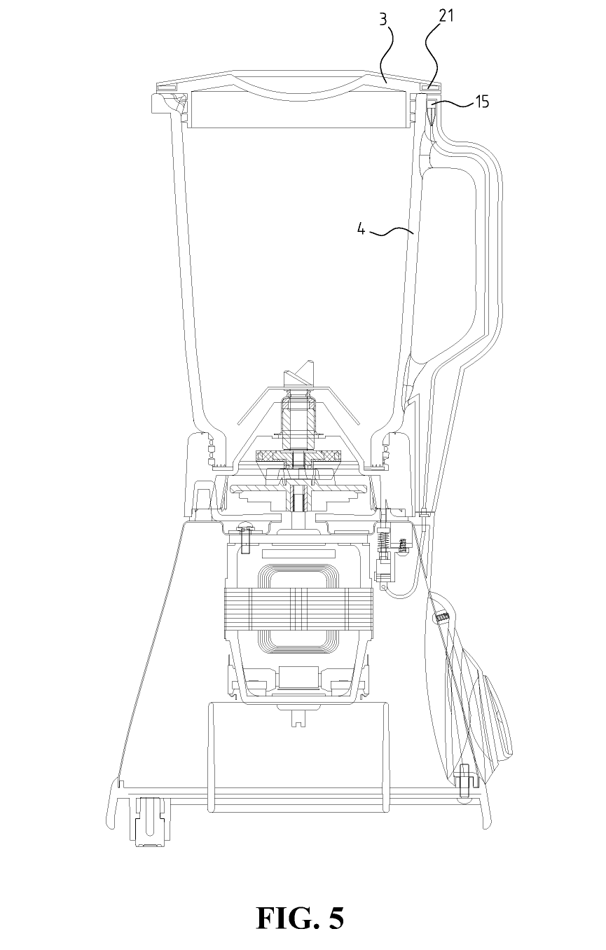

FIG. 5 shows a safety device to be applied to a fruit juice extractor according to a third preferred embodiment of the present invention. A magnetic sensor 15 is mounted on a sidewall close to an opening of the cup body 4, or another appropriate position on the sidewall of the cup body 4. A magnetic substance 21 is disposed on lower section of the lid 3 close to the edge. When the lid 3 securely covers the opening of the cup body 4, the magnetic substance 21 actuates the magnetic sensor 15 to transmit a signal to turn on the power. Thus the motor drives cutter device to rotate. When the lid 3 is removed from the cup body 4, the magnetic sensor 15 turns off the power.

Although the present invention has been described with reference to the preferred embodiments thereof it is apparent to those skilled in the art that a variety of modifications and changes may be made without departing from the scope of the present invention which is intended to be defined by the appended claims.

What is claimed is:

1. A juice extractor with a safety device, comprising
an extractor body having a feed channel;
a food pusher;
a cutter device mounted beneath the feed channel; and
a motor connected with the cutter device;
wherein the improvement comprises
a switching device disposed by the feed channel and electrically connected with a power source of the motor;
the food pusher having an actuating part;
the actuating part actuating the switching device to turn on the power of the motor when the food pusher is inserted into the feed channel; and
the switching device turning off the power of the motor when the food pusher is removed from the feed channel.

2. The juice extractor as claimed in claim 1, wherein the actuating part is a magnetic substance and the switching device is a magnetic sensor capable of detecting the presence of the magnetic substance and transmitting a signal.

3. The juice extractor as claimed in claim 2, wherein the magnetic substance is wrapped inside a sidewall of the food pusher.

4. The juice extractor as claimed in claim 1, wherein the switching device is a micro switch associated with a link and an elastic part capable of pushing the link away from the micro switch; and the actuating part is a pusher ridge on a surface of the food pusher and pushes the link toward the micro switch, thereby turning on the power; when the pusher ridge does not push the link, the micro switch turns off the power.

5. The juice extractor as claimed in claim 4, wherein the pusher ridge extends in a longitudinal direction along the sidewall of the food pusher; a groove is provided in a longitudinal direction on an inner sidewall of the feed channel allowing the pusher ridge to move along therein; the micro switch is located below the groove.

6. A juice extractor with a safety device, comprising
an extractor body having a feed channel;
a food pusher;
a cutter device mounted beneath the feed channel; and
a motor connected with the cutter device;
wherein the improvement comprises
a magnetic sensor and a safety handle disposed by the feed channel and electrically connected with a power source of the motor;
the food pusher having a magnetic substance;
the magnetic substance actuating the magnetic sensor to turn on the power of the motor when the food pusher is inserted into the feed channel and the safety handle is activated; and
the magnetic sensor turning off the power of the motor when the food pusher is removed from the feed channel or the safety handle is not activated.

7. The juice extractor as claimed in claim 6, wherein the magnetic substance is wrapped inside a sidewall of the food pusher.

8. A juice extractor with a safety device, comprising
a cup body having an opening;
a lid covering the opening of the cup body;
a cutter device mounted at the bottom of the cup body; and
a motor connected with the cutter device;
wherein the improvement comprises
a sidewall of the cup body provided with a magnetic sensor electrically connected with a power source of the motor;
the lid having a magnetic substance;
the magnetic substance actuating the magnetic sensor to turn on the power of the motor when the lid securely covers the opening of the cup body; and
the magnetic sensor turning off the power of the motor when the lid does not securely covers the opening of the cup body.
